(19) United States
(12) Patent Application Publication
(10) Pub. No.: US 2017/0328351 A1
(43) Pub. Date: Nov. 16, 2017

(54) COOLING AND LUBRICATING SYSTEM OF SPEED-UP GEAR BOX OF WIND POWER UNIT AND LOW-TEMPERATURE STARTING METHOD THEREOF

(71) Applicant: CSIC (CHONGQING) HAIZHUANG WINDPOWER EQUIPMENT CO.,LTD, Chongqing (CN)

(72) Inventors: Wanjun ZHANG, Chongqing (CN); Lulin NING, Chongqing (CN); Youchuan TAO, Chongqing (CN); Jinyu HUANG, Chongqing (CN); Zutian ZHOU, Chongqing (CN)

(73) Assignee: CSIC (CHONGQING) HAIZHUANG WINDPOWER EQUIPMENT CO. , LTD., Chongqing (CN)

(21) Appl. No.: 15/529,945

(22) PCT Filed: Feb. 4, 2016
(86) PCT No.: PCT/CN2016/073426

§ 371 Date: May 25, 2017

(30) Foreign Application Priority Data
Mar. 13, 2015 (CN) 201510110628.1

(51) Int. Cl. F03D 80/60; F03D 9/25; F16H 57/04; F03D 80/70; F16H 57/02

(52) U.S. Cl. CPC F03D 80/60; F16H 57/0416; F03D 9/255; F16H 57/0404; F16H 57/0413; F03D 80/70; F16H 57/045; F16H 57/0436; F16H 57/042; F16H 57/0417; F05B 2260/20; F05B 2260/98; F05B 2220/706; F16H 2057/02078; F16H 2700/00

(57) ABSTRACT

A lubricant cooler, a cooling and lubricating system of a speed-up gear box, a wind power unit and a low-temperature starting method of the wind power unit. The lubricant cooler includes a radiating plate and a one-way valve arranged on a lubricant conveying pipeline, wherein the radiating plate and the one-way valve are arranged in parallel, and the one-way valve and/or the lubricant conveying pipeline in communication with the one-way valve are integrated on the radiating plate. The lubricant cooler can solve the problem that, when the wind power unit is started at a low temperature, the cooling and lubricating system of the speed-up gear box causes the shut-down of the wind power unit because the lubricant blocks the radiating plate.

This application claims the benefit of priority to Chinese patent application No. 201510110628.1 titled “COOLING AND LUBRICATING SYSTEM OF SPEED-INCREASING GEARBOX OF WIND TURBINE GENERATOR SYSTEM AND LOW-TEMPERATURE STARTING METHOD THEREOF”, filed with the Chinese State Intellectual Property Office on Mar. 13, 2015, the entire disclosure of which is incorporated herein by reference.

### FIELD

The present application relates to the field of wind power generation technology, and particularly to a lubricant cooler, a cooling and lubricating system of a speed-increasing gearbox, a wind turbine generator system and a low-temperature starting method of the wind turbine generator system.

### BACKGROUND

North China has rich wind resources, and is a main wind power generator installation market currently and in the future. North region has a low air temperature from November to February of the next year, and has frequent weather conditions with temperature lower than 10 degrees Celsius below zero, and has a high air temperature in summer. Wind turbine generator systems in China are classified into low-temperature type systems and normal-temperature type systems according to the operation environment temperatures. The low-temperature type wind turbine generator system operates at the environment temperature ranging from 30 degrees Celsius below zero to 40 degrees Celsius, and the normal-temperature type wind turbine generator system operates at the environment temperature ranging from 10 degrees Celsius below zero to 40 degrees Celsius. Therefore, the wind turbine generator systems in the north are low-temperature type systems.

If the wind speed is lower than a cut-in wind speed, the wind turbine generator system will be switched into a standby mode; and if the system or the electrical grid fails, the wind turbine generator system will be switched into a stop or maintenance mode. When the wind turbine generator system is switched from the standby or stop mode to a grid-connected mode, in addition to the wind speed, various systems are also required to meet switching conditions, such as temperature of lubricant in the speed-increasing gearbox, generator winding temperature and the like. The wind turbine generator system may heat the lubricant in a lubricant tank of the speed-increasing gearbox and the generator winding by a heater in a stop or standby mode, or by idling of the wind rotor in a starting mode.

For the cooling and lubricating system of the speed-increasing gearbox, the above methods can only heat the lubricant in the lubricant tank of the speed-increasing gearbox, and has a slight heating effect or no heating effect to the lubricant in pipelines of the cooling and lubricating system and the lubricant in the cooler. A viscosity of the lubricant in the speed-increasing gearbox increases rapidly as the temperature drops, and according to the laboratory test results and the wind field operation experiences, the cooling pipeline generally has a large diameter, and when the temperature of the lubricant in the pipeline is about 30 degrees Celsius below zero, and the pressure at an outlet of a lubricant pump is close to an overflow pressure, the lubricant may flow back to the speed-increasing gearbox from the pipeline at a temperature control valve side. The interior of a fin-type heat dissipation plate commonly used in the cooling and lubricating system of the speed-increasing gearbox is constituted by multiple passages connected in parallel, and each passage has a small cross section. Though the system reaches the overflow pressure, once the temperature of the lubricant in the heat dissipation plate is lower than 0 degree Celsius, the lubricant cannot flow, resulting in that the heat dissipation plate is blocked and cannot operate normally.

A nacelle housing of the land wind turbine generator system generally has a non-sealed structure, and when the system is stopped or on standby in a low temperature environment, the temperature in the nacelle drops rapidly, and after the system has stopped for a long time, the temperature difference between the inside and the outside of the nacelle may be reduced to about 5 degrees Celsius. Since the heat dissipation plate has a large heat dissipation area, the temperature of the lubricant inside the heat dissipation plate may easily drop below 0 degrees Celsius. When the system is started at a low temperature, through in an initial stage, the lubricant in the speed-increasing gearbox can flow from the temperature control valve side back to the speed-increasing gearbox to perform lubrication, however, when the temperature of the lubricant increases, the pipeline at the temperature control valve side is closed, and the lubricant inside the heat dissipation plate is not heated and thus has a low temperature, and cannot flow back to the speed-increasing gearbox from the heat dissipation plate side, and thus the lubricant cannot cool or lubricate the speed-increasing gearbox, resulting in shut-down of the wind turbine generator system and the failure of the low-temperature starting. Therefore, one of key techniques of the low-temperature starting of the wind turbine generator system is the starting of the cooling and lubricating system of the speed-increasing gearbox, especially the heat dissipation plate.

The wind turbine generator system has heat generation components inside its nacelle, such as the speed-increasing gearbox, a generator, a convertor, and etc., therefore, a ventilation system is provided in the nacelle, and some coolers of the cooling and lubricating system of the speed-increasing gearbox are also arranged in the nacelle, and accordingly, the nacelle housing is provided with a vent. When the systems generates power in an off-grid mode, the components inside the nacelle generate few heat or has a low heating power. When a cooling fan of a cooler or a nacelle ventilation system is not in operation, the air outside the nacelle may also flow into or out of the nacelle via the vent, thus the temperature in the nacelle drops rapidly when the system is on standby or stopped, and the temperature in the nacelle rises slowly when the system is heated. Especially, the air flowing in the nacelle may increase convection and heat exchange between surfaces of the speed-increasing gearbox and the like, which is very detrimental to the low-temperature starting of the cooling and lubricating system of the speed-increasing gearbox.

For addressing the issues caused by the low temperature of the cooling and lubricating system of the speed-increasing gearbox, currently the wind turbine generator systems in the north mainly employs the following techniques. 1. The cooling and lubricating system of the speed-increasing gearbox employs an oil-water-air two-stage cooling system. Compared with the oil-air cooling and lubricating system, the oil-water-air cooling and lubricating system further requires a set of cooling water pump, a heat exchanger and corresponding pipelines, which increases the complexity and cost of the system. 2. An electric heater is provided in the nacelle. The nacelle has a large internal space, and requires numerous electric heaters, which increases the cost of the system and the electric heaters have a low utilization rate. Therefore, it is necessary and meaningful to provide a low-temperature starting technique for the wind turbine generator system, especially for the cooling and lubricating system of the speed-increasing gearbox, under the premise of not increasing the cost and complexity of the system.

### SUMMARY

In view of this, one of objects of the present application is to provide a lubricant cooler, which can address the issue in the low-temperature starting of the cooling and lubricating system of the speed-increasing gearbox. Moreover, the lubricant cooler is also applicable to machines in other low-temperature starting environments.

The above object of the present application is achieved by the following technical solutions.

The lubricant cooler according to the present application includes a heat dissipation plate and a one-way valve arranged in a lubricant conveying pipeline, the heat dissipation plate and the one-way valve are connected in parallel, and the one-way valve or the lubricant conveying pipeline in communication with the one-way valve is integrated on the heat dissipation plate. The heat dissipation plate and the one-way valve are connected in parallel, thus the lubricant conveying pipeline is divided into two branch conveying pipelines, to allow the lubricant to flow through the heat dissipation plate and the one-way valve respectively. Individual lubricant passages in the heat dissipation plate each have a small cross section, and the lubricant pipeline in communication with the one-way valve has a large cross section. According to the calculation formula of the turbulence frictional drag in a circular pipe: Δp=f(1/Re, Δ/d)*l/d)*(ρv^{2/}2) , the frictional drag of the lubricant pipeline in communication with the one-way valve is much less than that of the lubricant passages in the heat dissipation plate under the same condition. In normal operation, the pressure at an inlet of the heat dissipation plate cannot open the one-way valve, and when the heat dissipation plate is blocked since the lubricant in the heat dissipation plate has an increased viscosity as the temperature drops, the pressure at the inlet of the heat dissipation plate increases which in turn opens the one-way valve, and thus the external lubricant flows through the one-way valve, and at the same time, the lubricant with a high temperature flowing through the one-way valve can transmit heat to the lubricant in the heat dissipation plate to heat the lubricant and increase the temperature of the lubricant, and in turn clears the heat dissipation plate, which prevents shut-down of the system caused when the heat dissipation plate is blocked by the lubricant with a low temperature.

Further, the one-way valve or the lubricant conveying pipeline in communication with the one-way valve is integrated inside the heat dissipation plate.

Further, the lubricant cooler further includes a cooling fan for blowing air toward the heat dissipation plate.

The second object of the present application is to provide a cooling and lubricating system of a speed-increasing gearbox equipped with the above lubricant cooler, and the cooling and lubricating system of the speed-increasing gearbox is applied in a wind turbine generator system, and can address the issue that the wind turbine generator system is shutdown since the lubricant blocks the heat dissipation plate when the wind turbine generator system is started up at a low temperature.

Further, the cooling and lubricating system of the speed-increasing gearbox according to the present application includes a double-speed lubricant pump, an overflow valve, a filter, a temperature control valve, a lubricant dispenser, a heater, and a speed-increasing gearbox. An inlet of the double-speed lubricant pump is in communication with the speed-increasing gearbox, and an outlet of the double-speed lubricant pump is in communication with the speed-increasing gearbox via a first pipeline, and the overflow valve is arranged in the first pipeline. The outlet of the double-speed lubricant pump is in communication with an inlet of the filter via a second pipeline, and an outlet of the filter is in communication with the lubricant dispenser via a third pipeline and a fourth pipeline respectively, the lubricant cooler is arranged in the third pipeline, and the temperature control valve is arranged in the fourth pipeline. The temperature control valve is a normally open temperature control valve. When the temperature of the lubricant is higher than a first preset temperature t1, a valve port of the temperature control valve is closed gradually, and the valve port is completely closed till the temperature of the lubricant reaches a second preset temperature t2; and the lubricant dispenser is in communication with the speed-increasing gearbox.

The third object of the present application is to provide a wind turbine generator system equipped with the above cooling and lubricating system of the speed-increasing gearbox. Due to being equipped with the cooling and lubricating system of the speed-increasing gearbox according to the present application, the wind turbine generator system can realize starting in a low temperature environment without increasing the complexity of the system and manufacturing cost of the system compared with the conventional technology. In addition, the wind turbine generator system can address the issues that the temperature in the nacelle drops rapidly when the system is on standby or stopped and the temperature in the nacelle rises slowly when the system is heated which are both caused by arranging the ventilation system in the nacelle and do not facilitate the low temperature starting.

The above object of the present application is achieved by the following technical solutions.

The wind turbine generator system according to the present application includes a nacelle housing, and an air inlet of the cooling and lubricating system of the speed-increasing gearbox in the nacelle housing is provided with a cover plate capable of being open and close, and the cover plate of the air inlet is closed in seasons with a low temperature.

The fourth object of the present application is to provide a low-temperature starting method of the wind turbine generator system, and the wind turbine generator system can be smoothly started in a low temperature environment with this method.

The above object of the present application is achieved by the following technical solutions.

The low-temperature starting method of the wind turbine generator system according to the present application includes performing the following steps in low temperature starting:

S1) first heating a lubricant in a lubricant tank by a heater of the speed-increasing gearbox;

S2) starting the double-speed lubricant pump to work first in a low speed state, and then pumping the lubricant from the lubricant tank of the speed-increasing gearbox to the cooling and lubricating system, wherein in this case, the lubricant cannot flow through the cooler under the action of a pressure of the lubricant pump, and the lubricant enters the filter and flows back to the speed-increasing gearbox through the fourth pipeline; and

S3) connecting the wind turbine generator system to an electrical grid to generate power, to allow the temperature of the lubricant in the speed-increasing gearbox to rise gradually, to gradually close the temperature control valve in the fourth pipeline, and to allow the pressure at an inlet of the cooler in the third pipeline to continuously increase, to open the one-way valve in the cooler, to further allow part of the lubricant with a high temperature to flow from the fourth pipeline side back to the speed-increasing gearbox via the one-way valve connected in parallel with the heat dissipation plate, wherein, when the lubricant with a high temperature flows through the one-way valve, heat is transmitted to the heat dissipation plate from the one-way valve, to heat the lubricant inside the heat dissipation plate, to finally allow the lubricant to flow through the whole heat dissipation plate, to enable the cooling and lubricating system of the speed-increasing gearbox to work normally, to achieve normal starting of the wind turbine generator system at a low temperature.

The beneficial effects of the present application are as follows.

1. The lubricant cooler according to the present application can achieve normal starting at a low temperature, and can address the issue that the wind turbine generator system is shutdown since the lubricant blocks the heat dissipation plate when the wind turbine generator system is started up at a low temperature.

2. The cooling and lubricating system of the speed-increasing gearbox according to the present application is applied in the wind turbine generator system, and can address the issue that the wind turbine generator system is shutdown since the lubricant blocks the heat dissipation plate when the wind turbine generator system is started up at a low temperature.

3. Due to being equipped with the cooling and lubricating system of the speed-increasing gearbox according to the present application, the wind turbine generator system according to the present application can realize starting in a low temperature environment without increasing the complexity of the system and manufacturing cost of the system compared with the conventional technology.

4. With the low-temperature starting method of the wind turbine generator system according to the present application, the wind turbine generator system can be started smoothly at the low temperature environment.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only examples of the present application, and for the person skilled in the art, other drawings may be obtained based on the drawings without any creative efforts.

FIG. 1 is a structural view showing a heat dissipation plate and a one-way valve connected in parallel in a lubricant cooler according to the present application, and arrows in the figure indicate flowing directions of the lubricant;

FIG. 2 is a schematic diagram of a cooling and lubricating system of a speed-increasing gearbox according to an embodiment of the present application; and

FIG. 3 is a schematic view showing the structure of a nacelle housing in the wind turbine generator system according to the present application.

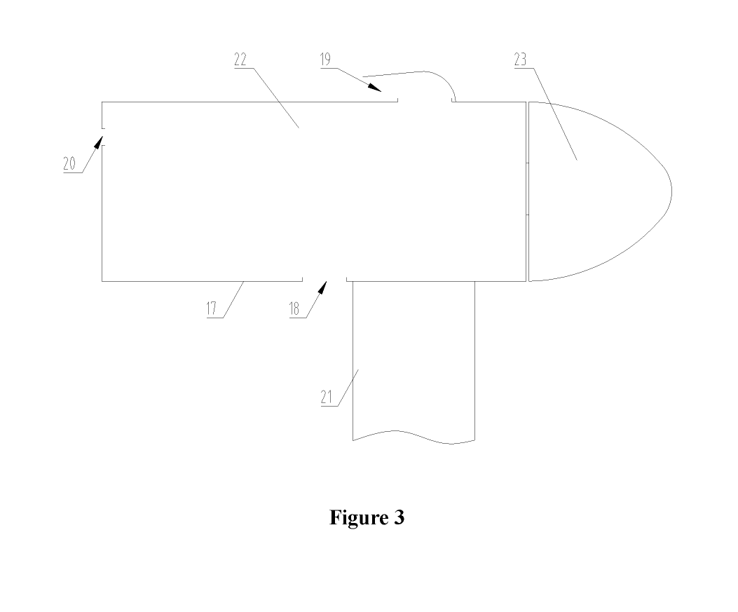

### DETAILED DESCRIPTION

The technical solutions in the embodiments of the present application will be described clearly and completely hereinafter in conjunction with the drawings in the embodiments of the present application. Apparently, the described embodiments are only one part of the embodiments of the present application, rather than all embodiments. Based on the embodiments in the present application, all of other embodiments, made by the person skilled in the art without any creative efforts, fall into the scope of the present application.

### First Embodiment: Lubricant Cooler

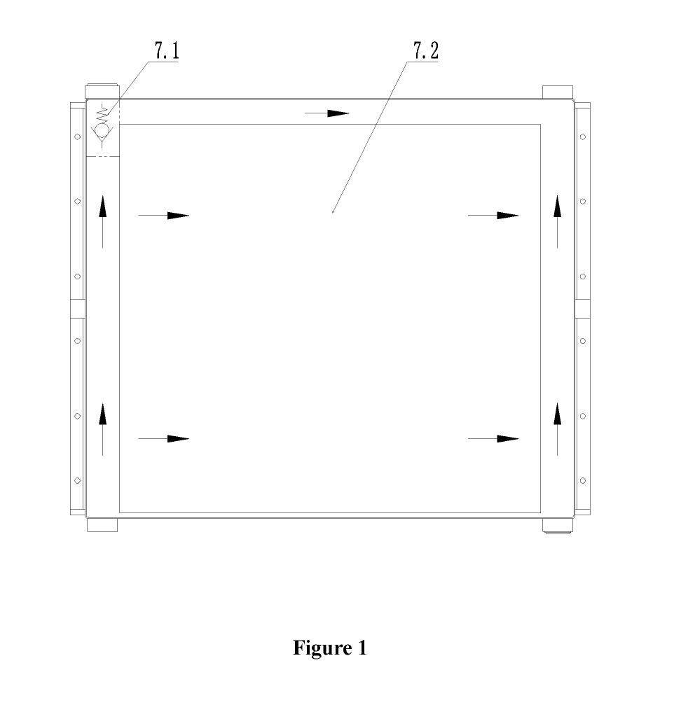

As shown in FIG. 1, the lubricant cooler according to the present application includes a heat dissipation plate 7.2 and a one-way valve 7.1 configured to be arranged on a lubricant conveying pipeline. The heat dissipation plate 7.2 and the one-way valve 7.1 are connected in parallel, and the one-way valve 7.1 or the lubricant conveying pipeline 6 in communication with the one-way valve 7.1 is integrated on the heat dissipation plate 7.2. Preferably, the one-way valve 7.1 or the lubricant conveying pipeline 6 in communication with the one-way valve 7.1 is integrated inside the heat dissipation plate 7.2, to maximum the efficiency in transferring heat from the one-way valve 7.1 or from the lubricant conveying pipeline in communication with the one-way valve 7.1 to the heat dissipation plate 7.2. Preferably, the lubricant cooler further includes a cooling fan 7.3 for cooling and venting of the heat dissipation plate 7.2, to improve the heat dissipation efficiency of the heat dissipation plate 7.2. Of course, the cooler 7 may not include the cooling fan 7.3, and employs a natural convection cooling. The cooler 7 may further be applicable to other liquids with viscosity-temperature property similar to that of the lubricant of the speed-increasing gearbox of the wind turbine generator, and may be applicable to a liquid-air heat exchange and a liquid-liquid heat exchange. The heat dissipation plate and the one-way valve are connected in parallel, thus, the lubricant conveying pipeline 6 is divided into two branch conveying pipelines to allow the lubricant to flow through the heat dissipation plate and the one-way valve respectively. In normal operation, the pressure at an inlet of the heat dissipation plate cannot open the one-way valve, and when the heat dissipation plate is blocked since the lubricant in the heat dissipation plate has a low temperature, the external lubricant flows through the one-way valve, thus the lubricant with a high temperature flowing through the one-way valve can transmit heat to the lubricant in the heat dissipation plate, and in turn clears the heat dissipation plate, which prevents shut-down of the machine caused when the heat dissipation plate is blocked by the lubricant with a low temperature. The lubricant cooler according to the present application can realize normal starting at the low temperature, and can address the issue that the wind turbine generator system is shutdown since the lubricant with a low temperature blocks the heat dissipation plate when the wind turbine generator system is started up at a low temperature.

### Second Embodiment: Cooling and Lubricating System of the Speed-Increasing Gearbox, wind Turbine Generator System Using the Cooling and Lubricating System of the Speed-Increasing Gearbox, and Low-Temperature Starting Method of the Wind Turbine Generator System

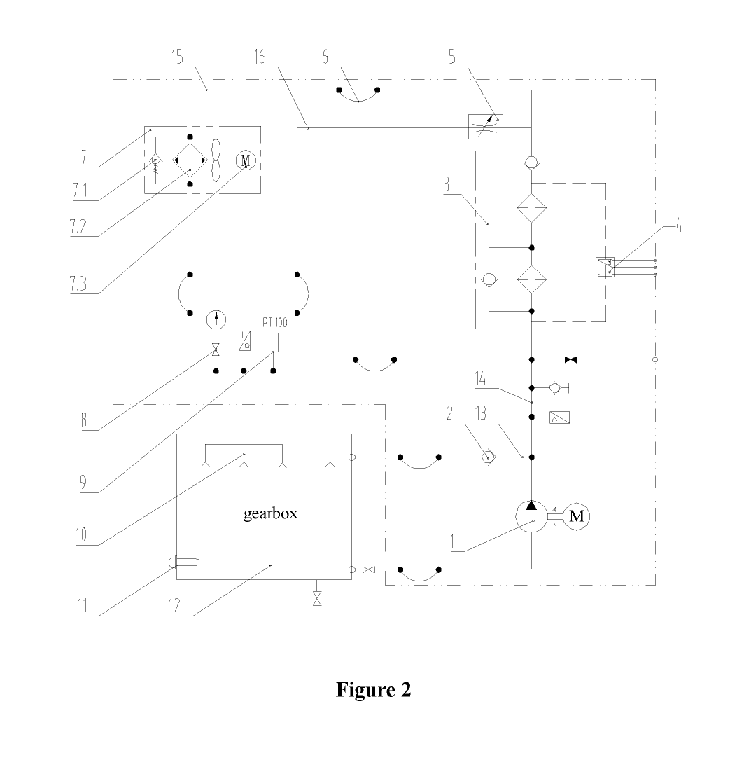

The cooling and lubricating system of the speed-increasing gearbox according to the present application, as shown in FIGS. 1 and 2, includes a double-speed lubricant pump 1, an overflow valve 2, a filter 3 and a differential pressure sensor 4, a temperature control valve 5, a lubricant conveying pipeline 6, a lubricant cooler 7, a lubricant dispenser 10, a heater 11 and a speed-increasing gearbox 12. The cooler 7 preferably includes a one-way valve 7.1, a heat dissipation plate 7.2 and a cooling fan 7.3. The one-way valve 7.1 is integrated on the heat dissipation plate 7.2 by parallel connection, as shown in FIG. 1. Preferably, the cooling and lubricating system of the speed-increasing gearbox according to this embodiment may further include a pressure sensor 8 configured to measure the pressure of the lubricant flowing into the lubricant dispenser via the cooler, and a temperature sensor 9 configured to measure the temperature of the lubricant flowing into the lubricant dispenser via the temperature control valve. An inlet of the double-speed lubricant pump 1 is in communication with the speed-increasing gearbox 12, and an outlet of the double-speed lubricant pump 1 is in communication with the speed-increasing gearbox 12 via a first pipeline 13. The overflow valve 2 is arranged in the first pipeline 13. The outlet of the double-speed lubricant pump 1 is in communication with an inlet of the filter 3 via a second pipeline 14, and an outlet of the filter 3 is in communication with the lubricant dispenser 10 via a third pipeline 15 and a fourth pipeline 16 respectively. The lubricant cooler 7 is arranged in the third pipeline 15, and the temperature control valve 5 is arranged in the fourth pipeline 16, and the temperature control valve 5 is a normally open temperature control valve. When the temperature of the lubricant is higher than a first preset temperature t1, a valve port of the temperature control valve is closed gradually, and the valve port is completely closed till the temperature of the lubricant reaches a second preset temperature t2. The lubricant dispenser 7 is in communication with the speed-increasing gearbox 12.

In normal operation, the double-speed lubricant pump 1 starts to work at a low speed firstly, and the lubricant is pumped from a lubricant tank of the speed-increasing gearbox 12 to the cooling and lubricating system. If the cooling and lubricating system has faults such as blockage which causes the pressure at the outlet of the double-speed lubricant pump 1 to be higher than a system safety pressure, the overflow valve 2 opens, and the lubricant flows back to the speed-increasing gearbox 12 from the overflow valve 2 to achieve the function of protecting the system; otherwise, the lubricant flows into the filter 3. The lubricant flows back to the speed-increasing gearbox 12 via two paths after being filtered, and one path is through the temperature control valve 5 and the other path is through the cooler 7.

The temperature control valve 5 is open normally, and acts within the temperature interval [t1, t2]. When the temperature of the lubricant flowing through the temperature control valve 5 is lower than t1, the temperature control valve 5 is in an open state; and the valve port of the temperature control valve 5 is gradually closed when the temperature of the lubricant is equal to or greater than t1, and is completely closed till the temperature of the lubricant reaches the temperature t2. When the temperature of the lubricant is lower than t1, most part of the lubricant flows back to the speed-increasing gearbox 12 through the temperature control valve 5 and the lubricant dispenser 10, and the rest of the lubricant flows back to the speed-increasing gearbox 12 through the cooler 7 and the lubricant dispenser 10. When the temperature of the lubricant is higher than t1, the lubricant flowing through the heat dissipation plate of the cooler 7 gradually increases, to reduce the temperature of the lubricant. When the temperature of the lubricant is higher than t3, the cooling fan 7.3 of the cooler starts, to further increase the cooling power of the heat dissipation plate of the cooler 7. When the temperature of the lubricant is higher than t2, the temperature control valve is closed completely, and all the lubricant flows through the cooler 7 to be cooled, and t3 is within the temperature interval [t1, t2].

The wind turbine generator system according to the present application includes a rotor 23, a nacelle 22 and a tower 21. For ensuring the starting performance of the cooling and lubricating system of the speed-increasing gearbox at a low temperature, the cooler 7 is arranged in the nacelle 22 of the wind turbine generator system at a position close to the speed-increasing gearbox 12, and air flows in through an air inlet 18 at the bottom of a nacelle housing 17, and flows out from an air outlet 19. For meeting the ventilation requirement of the nacelle, a vent 20 is provided at a tail portion of the nacelle housing. A cover plate capable of being opened and closed is provided at the air inlet 18. The cover plate at the air vent is open in normal conditions, and the cover plate closes the air inlet 18 in seasons with a low temperature, thus, on the premise that the ventilation requirement of the cooling and lubricating system of the speed-increasing gearbox is met, external air with a low temperature is restricted from entering the nacelle, which reduces the dropping speed of the temperature in the nacelle when the system is on standby or stopped, and increases the rising speed of the temperature in the nacelle in the low-temperature starting, reduces convection and heat transfer between the components such as the speed-increasing gearbox, and ensures the heating effects of the speed-increasing gearbox, the cooling pipeline, the generator and the like in the low-temperature starting.

The low-temperature starting method of the wind turbine generator system includes the following steps. First, the lubricant in the lubricant tank is heated by the heater 11 of the speed-increasing gearbox to a certain temperature. The double-speed lubricant pump 1 starts at a low speed. Due to the low temperature, the lubricant at this time cannot flow through the heat dissipation plate 7.2, and all the lubricant flows back to the speed-increasing gearbox 12 through the temperature control valve 5 and the lubricant dispenser 10. As the wind turbine generator system is connected to the electrical grid to generate power, the temperature of the lubricant in the speed-increasing gearbox gradually rises, and when the temperature is greater than t1, the temperature control valve 5 is gradually closed, which allows the pressure at an inlet end of the cooler 7 to gradually increase and in turn open the one-way valve 7.1, thus part of the lubricant with a high temperature flows back to the speed-increasing gearbox through the one-way valve 7.1 and the lubricant dispenser 10, and the rest most part of the lubricant flows back to the speed-increasing gearbox through the temperature control valve 5 and the lubricant dispenser 10. When the lubricant with a high temperature flows through the one-way valve 7.1, heat is transmitted from the one-way valve 7.1 to the heat dissipation plate 7.2, to allow the temperature of the side, close to one-way valve 7.1, of the heat dissipation plate 7.2 to rise gradually, and thus allowing part of the lubricant with a high temperature at the cooler side to flow through this region of the heat dissipation plate 7.2, and further gradually transmit heat to the whole heat dissipation plate 7.2, to finally allow the lubricant to flow through the whole heat dissipation plate 7.2, thereby allowing the cooling and lubricating system to operate normally.

Finally, it is to be noted that, the above embodiments are only intended to illustrate technical solutions of the present application rather than limit the present application. Though the present application is described in detail with reference to the preferred embodiments, it should be appreciated by the person skilled in the art that, modifications or equivalent substitutions may be made to the technical solutions of the present application without departing from the purpose and scope of the technical solutions of the present application, and these modifications or equivalent substitutions are also deemed to fall into the scope of the present application defined by the claims.

1. A lubricant cooler, comprising a heat dissipation plate and a one-way valve configured to be arranged in a lubricant conveying pipeline, wherein the heat dissipation plate and the one-way valve are connected in parallel, and the one-way valve or the lubricant conveying pipeline in communication with the one-way valve is integrated on the heat dissipation plate.

2. The lubricant cooler according to claim 1, wherein the one-way valve or the lubricant conveying pipeline in communication with the one-way valve is integrated inside the heat dissipation plate.

3. A cooling and lubricating system of a speed-increasing gearbox, equipped with a lubricant cooler, and the lubricant cooler comprises a heat dissipation plate and a one-way valve configured to be arranged in a lubricant conveying pipeline, wherein the heat dissipation plate and the one-way valve are connected in parallel, and the one-way valve or the lubricant conveying pipeline in communication with the one-way valve is integrated on the heat dissipation plate.

4. The cooling and lubricating system of the speed-increasing gearbox according to claim 3, further comprising a double-speed lubricant pump, an overflow valve, a filter, a temperature control valve, a lubricant dispenser, a heater, and a speed-increasing gearbox, wherein an inlet of the double-speed lubricant pump is in communication with the speed-increasing gearbox, and an outlet of the double-speed lubricant pump is in communication with the speed-increasing gearbox via a first pipeline, and the overflow valve is arranged in the first pipeline; the outlet of the double-speed lubricant pump is in communication with an inlet of the filter via a second pipeline, and an outlet of the filter is in communication with the lubricant dispenser via a third pipeline and a fourth pipeline respectively, the lubricant cooler is arranged in the third pipeline, and the temperature control valve is arranged in the fourth pipeline, and the temperature control valve is a normally open temperature control valve; and a valve port of the temperature control valve is closed gradually when a temperature of a lubricant is higher than a first preset temperature t1, and is completely closed till the temperature of the lubricant reaches a second preset temperature t2; and the lubricant dispenser is in communication with the speed-increasing gearbox.

5. A wind turbine generator system, equipped with the cooling and lubricating system of the speed-increasing gearbox according to claim 4.

6. The wind turbine generator system according to claim 5, comprising a nacelle housing, wherein the nacelle housing has an air inlet and an air outlet for ventilation of the cooling and lubricating system of the speed-increasing gearbox, a cover plate capable of being open and close is arranged at the air inlet, and the cover plate of the air inlet is closed in seasons with a low temperature.

7. A low-temperature starting method of the wind turbine generator system according to claim 5, wherein in low-temperature starting, the following steps are performed:
S1) first heating a lubricant in a lubricant tank by a heater of the speed-increasing gearbox;
S2) starting the double-speed lubricant pump to work first in a low speed state, and then pumping the lubricant from the lubricant tank of the speed-increasing gearbox to the cooling and lubricating system, wherein in this case, the lubricant cannot flow through the cooler under the action of a pressure of the lubricant pump, and the lubricant enters the filter and flows back to the speed-increasing gearbox through the fourth pipeline; and
S3) connecting the wind turbine generator system to an electrical grid to generate power, to allow the temperature of the lubricant in the speed-increasing gearbox to rise gradually, to gradually close the temperature control valve in the fourth pipeline, and to allow the pressure at an inlet of the cooler in the third pipeline to continuously increase, to open the one-way valve in the cooler, to further allow part of the lubricant with a high temperature to flow from the fourth pipeline side back to the speed-increasing gearbox via the one-way valve connected in parallel with the heat dissipation plate, wherein, when the lubricant with a high temperature flows through the one-way valve, heat is transmitted to the heat dissipation plate from the one-way valve, to heat the lubricant inside the heat dissipation plate, to finally allow the lubricant to flow through the whole heat dissipation plate, to enable the cooling and lubricating system of the speed-increasing gearbox to work normally, to achieve normal starting of the wind turbine generator system at a low temperature.

8. The cooling and lubricating system of the speed-increasing gearbox according to claim 3, wherein the one-way valve or the lubricant conveying pipeline in communication with the one-way valve is integrated inside the heat dissipation plate.

9. The cooling and lubricating system of the speed-increasing gearbox according to claim 8, further comprising a double-speed lubricant pump, an overflow valve, a filter, a temperature control valve, a lubricant dispenser, a heater, and a speed-increasing gearbox, wherein an inlet of the double-speed lubricant pump is in communication with the speed-increasing gearbox, and an outlet of the double-speed lubricant pump is in communication with the speed-increasing gearbox via a first pipeline, and the overflow valve is arranged in the first pipeline; the outlet of the double-speed lubricant pump is in communication with an inlet of the filter via a second pipeline, and an outlet of the filter is in communication with the lubricant dispenser via a third pipeline and a fourth pipeline respectively, the lubricant cooler is arranged in the third pipeline, and the temperature control valve is arranged in the fourth pipeline, and the temperature control valve is a normally open temperature control valve; and a valve port of the temperature control valve is closed gradually when a temperature of a lubricant is higher than a first preset temperature t1, and is completely closed till the temperature of the lubricant reaches a second preset temperature t2; and the lubricant dispenser is in communication with the speed-increasing gearbox.
